(19) United States
(12) Patent Application Publication
(10) Pub. No.: US 2012/0001841 A1
(43) Pub. Date: Jan. 5, 2012

(54) IDENTIFYING AMBIENT LIGHT TYPE AND ILLUMINANCE COMPENSATION USING A PLURALITY OF PHOTODETECTORS

(76) Inventors: JEFF GOKINGCO, Austin, TX (US); WAYNE T. HOLCOMBE, Mountain View, CA (US); MIROSLAV SVAJDA, San Jose, CA (US)

(21) Appl. No.: 12/826,947

(22) Filed: Jun. 30, 2010

(51) Int. Cl. G09G 3/36; G01D 18/00; G01J 1/18; G01J 3/50

(52) U.S. Cl. 345/102; 356/51; 702/85

(57) ABSTRACT

A method for determining an ambient light type is described. The method includes receiving measurement information from multiple photodetectors configured for different light spectra, calculating a color ratio using the measurement information, obtaining a correction value using the color ratio, applying the correction value to at least one of the first and second measurement information to obtain a photopic illuminance value, and determining an ambient light type using the photopic illumination value and the color ratio.

### BACKGROUND

Many consumer electronic devices include displays such as liquid crystal displays or light emitting diode displays that implement some type of backlight source. In general, these displays can consume a great amount of power, particularly in the realm of portable devices such as cellular telephones, portable digital assistants, videogames and so forth. In addition, many of these same devices include a reflectance based proximity sensor.

To reduce power consumption in such devices, attempts are made to provide a detection mechanism to detect ambient light conditions to aid in determining an appropriate amount of illumination to be provided by the display based on an environment in which the display is located. Such a detector can be implemented using a high quality photodetector that is closely matched to a human photopic response. This optical processor can be integrated with a reflectance proximity sensor which can be used in many display applications to support various display and touch sensor inputs, enabling and disabling them as appropriate to reduce power and prevent spurious inputs (such as disabling the touch display when a cell phone is held to the head). Yet difficulties remain with available detectors.

### SUMMARY OF INVENTION

According to one aspect of the present invention, a method for determining an ambient light type can be performed. The method includes receiving measurement information from multiple photodetectors configured for different light spectra, obtaining a correction value using a color ratio obtained from the measurement information, DC ambient level, and amplitude to DC of frequency components, applying the correction value to at least one of the measurement information to obtain a photopic illuminance value. Using this information, an ambient light type can be determined. Based on the ambient light type, one or more components of a system such as display of a portable device can be controlled accordingly.

Another aspect of the present invention is directed to an apparatus including multiple photodetectors to detect energy in different light spectra, and a controller to receive information from the photodetectors. The controller may calculate a color ratio between information from the first and second photodetectors, and determine an ambient light type present in a proximity of the apparatus based at least in part on the color ratio and measurement information and characteristics of the measurement information from one of the photo detectors. The controller may also perform an algorithm for calculating photopic illuminance value based on color ratio and ambient light type.

The apparatus can further include a multiplexer coupled to receive measurements from the photodetectors and to select for output a measurement, an amplifier to amplify the selected measurement, a comparator to compare the selected measurement to a threshold value, and a buffer coupled to the comparator to output a pulse width modulated signal representative of the comparator output. The apparatus, which may include a proximity detector having the photodetectors, can be included in various systems such as a portable device having a processor to perform application program instructions, a transceiver to transmit and receive radio frequency (RF) signals, a display to display information to a user, and the controller.

### BRIEF DESCRIPTION OF THE DRAWINGS

FIG. 1 is a block diagram of a sensor device in accordance with an embodiment of the present invention.

FIG. 2 shows a block diagram of a system in accordance with one embodiment of the present invention.

FIG. 3 is a flow diagram of a method in accordance with one embodiment of the present invention.

FIG. 4 illustrates a programming sequence in accordance with one embodiment of the present invention.

FIG. 5 is a block diagram of a system in accordance with another embodiment of the present invention.

### DETAILED DESCRIPTION

In various embodiments, a mechanism for determining a human-perceived brightness may be realized without using photodetectors (such as photodiodes) that are matched to a human eye response. Accordingly, using an embodiment of the present invention, inexpensive photodiodes may be used in an integrated circuit (IC) to provide improved performance with fewer design constraints. In addition, embodiments may further estimate an ambient light type present in a location of the IC.

In various embodiments, an IC may include multiple photodetectors, e.g., two photodiodes, neither of which are matched to a human eye photopic response curve. Such diodes may be configured to operate at different wavelengths. For example, in one embodiment, a first photodiode may be configured to have a response that peaks within a visible light spectrum and a second photodiode may be configured to have a response that peaks within an infrared light spectrum. Information from these two diodes may be used to determine a photopic illuminance value, i.e., a lux value, and an ambient light type. More specifically, using measurement information obtained from the diodes, a color ratio between the visible light and infrared light photodiodes can be calculated. Put another way, the measurement information provides a color ratio, i.e., a ratio between a signal strength of the detected energies, as represented by the visible light measurement and the infrared light measurement. A high color ratio indicates more visible blue weighted response relative to the infrared weighted response. It is noted that this color ratio may be influenced by the type of light present, as each light source includes a characteristic mix of infrared and visible light. For example, when an ambient light source is an incandescent light bulb, the color ratio is low, indicating that most of the light is in the infrared region, rather than in the visible region. If the light type is fluorescent or white LED, the color ratio will be highly weighted towards the visible light region. Thus, blackbody radiator light sources, such as incandescent or halogen lamps, can have significant energy in the infrared spectrum. On the other hand, fluorescent lamps have more energy in the visible light spectrum. The color ratio thus describes the relative strength of the visible photodiode reading relative to the infrared photodiode reading.

Based on the color ratio determination and other information, a correction value may be obtained. This correction value may be a value that acts to correct for the difference in response between a silicon photodiode and the human eye photopic response and thus may act to more closely match the photodiode outputs to a human eye photopic response curve. In one embodiment, this correction value may be based on collected characterization data, which may be data that are dynamically or statically obtained and preprogrammed into a device. For example, a lookup table may include information corresponding correction values with color ratios. Such correction values may be applied to at least one of the photodiode output values to obtain an approximate photopic illuminance lux value.

In addition to being based on color ratio, the ambient light type may further be a function of signal strength information and electrical waveform properties such as frequency components and AC to DC ratio. Embodiments thus may use signal strength information, frequency, AC to DC ratios, and/or color ratio to determine an ambient light type. Based on this information, an ambient light type in an environment which the IC is located can be determined. For example, based on the color ratio, frequency, AC to DC ratios, and signal strength, the ambient light type may be identified as direct sunlight (e.g., moderate color ratio, low AC, absolute strong DC signal), black body radiator light source (e.g., incandescent and halogen environments—low color, 100-120 Hz frequency component with a 10% peak to peak AC to DC value, small to moderate signal), or fluorescent (e.g., compact fluorescent light or white LED, high color ratio, combination of high frequency waveform from 40 KHz to 120 KHz at several percent peak to peak value with 100 Hz-120 Hz low frequency component, small to moderate signal).

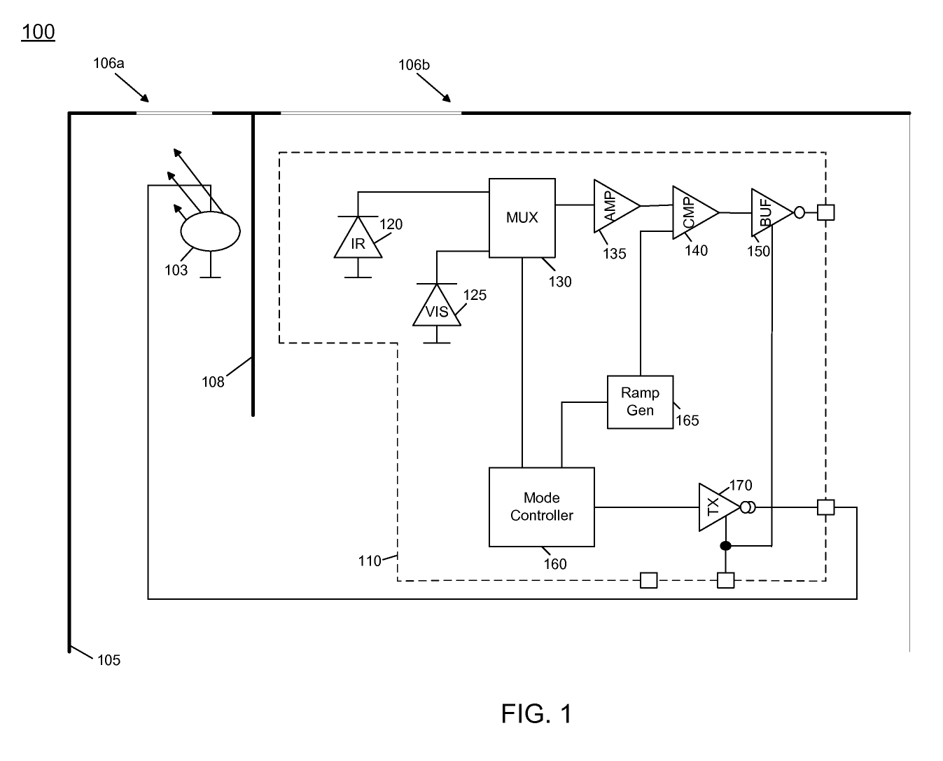

Referring now to FIG. 1, shown is a block diagram of a sensor device in accordance with an embodiment of the present invention. As seen, device 100 may be configured as a sensor package that includes one or more semiconductor die and associated devices such as an infrared emitter. Specifically, device 100 may be implemented within a package 105 that includes a plurality of transparent windows 106a and 160b to enable transmission of an infrared signal out of the package for use in reflectance proximity sensor, as well as to enable receipt of incoming energy, within both the visible light and infrared spectra.

As seen, package 105 includes an infrared emitter 103 which in one embodiment may be a light emitting diode (LED) that receives a signal from a semiconductor die 110 to enable transmission of an infrared signal out of first transparent window 106a. This emitter may be separated from the circuitry of die 110 by an optical block 108 such as a plastic barrier. Reflective infrared energy may be received through transparent window 106_{b} by a photodetector 120, which in one embodiment may be an infrared-configured photodiode. In addition, another photodetector, namely photodetector 125 may receive incoming energy of the visible light spectrum. In one embodiment, photodetector 125 may be a photodiode configured for the visible light spectrum. These two photodiodes may employ different p-n junctions.

In one embodiment, visible light photodiode 125 peaks at around 530 nm. On the other hand, infrared photodiode 120 peaks at around 830 nm. Although the visible-light photodiode peaks near 550 nm (considered the peak wavelength of human perception), the visible photodiode extends to infrared light as well. Similarly, the infrared photodiode detects infrared light as well as part of the visible light spectrum. Note that the photodiodes may treat ultraviolet, visible, and infrared light as a continuous spectrum.

Various signal processing may be performed on die 110. Generally, incoming energy of both infrared and visible light spectra may be captured by the photodetectors and processed to generate output signals, which may be provided to another device such as a microcontroller or other control logic that can further process the information, e.g., to generate ambient light information such as ambient light type and proximity information. In general, the circuitry of die 110 may be controlled by a controller 160 which in one embodiment may be a mode controller. As seen, mode controller 160 is coupled to provide a selection signal to a multiplexer 130 which is configured to receive the outputs from the two photodetectors, which in one embodiment may be currents having a value based upon the received amount of energy. Multiplexer 130 may output the selected signal to an amplifier 135, which may amplify the current and provide it to a comparator 140. Comparator 140 may be configured to perform a comparison between this incoming signal and an output of a ramp generator 165 which in turn is controlled by controller 160. The ramp generator may output threshold values for the comparison based on the type of signal selected for processing by controller 160. The output of comparator 140 is a signal indicative of the measured amount of energy received in the corresponding photodetector. This information is buffered in a buffer 150 and output, e.g., as a pulse width modulated (PWM) signal. As will be discussed further below, the signal may be provided to an associated controller such as a microcontroller unit.

Note that controller 160 may further provide an output to a transmitter 170, which may output a current to drive infrared emitter 103. In one implementation, semiconductor die 110 may be fabricated using a CMOS process, although the scope of the present invention is not so limited. Further, while the detector of FIG. 1 is shown with this particular implementation, embodiments may be incorporated in other manners.

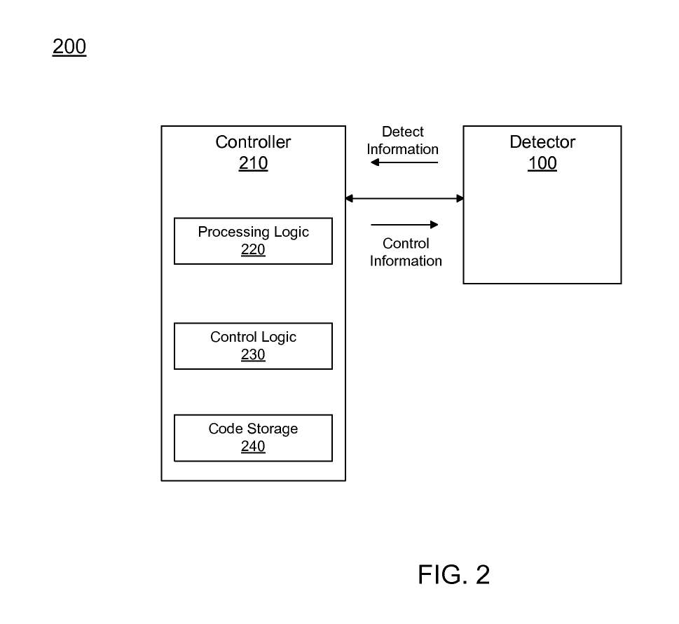

FIG. 2 shows a block diagram of a system in accordance with an embodiment of the present invention. Specifically, FIG. 2 shows a system in which a detector is coupled to a controller that can be used to both control operation of the detector as well as to receive detection information from the detector and to perform various processing on the information, e.g., to make an ambient light determination and to perform proximity distance measurements. Specifically, system 200, which may be a portion of a portable device including a processor, display and other such circuitry, for example, a PDA, a mobile phone or computer, etc., includes a detector 100 and a controller 210. In one embodiment, controller 210 may be a microcontroller unit, although the scope of the present invention is not so limited. As seen in the exemplary embodiment of FIG. 2, controller 210 may generally include a processing logic 220, control logic 230 and a code storage 240. Processing logic 220 may include, in one embodiment, an analog-to-digital converter (ADC) to convert incoming PWM signals into digital signals for further processing in processing logic 220, e.g., under control of control logic 230. Code storage 240 may store one or more algorithms in accordance with an embodiment of the present invention to enable control of the detector as well as to handle processing of information received from the detector. Such code may be stored in a computer-readable storage medium such as a read only memory, flash memory or so forth.

As seen, control information may be sent from controller 210 to detector 100. Such control information may indicate a mode in which the detector is to operate, and may be sent to mode controller 160 (shown in FIG. 1). In turn, energy detection information, e.g., in the way of PWM signals, may be provided from detector 100 to controller 210. Based on one or more programs stored in program storage 240, controller 210 may, after calculation of a color ratio and correction information, and in some embodiments, waveform shape, determine an ambient light type present in the environment of the detector, as well as to perform proximity sense calculations. Based on such information, controller 210 may either directly or indirectly control a display, speaker, and/or other components of system 200 (not shown in FIG. 2 for ease of illustration).

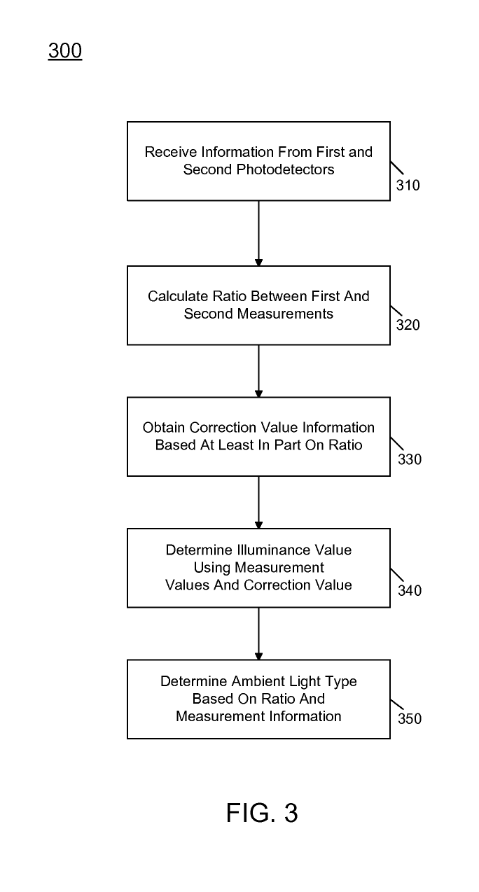

Referring now to FIG. 3, shown is a flow diagram of a method in accordance with one embodiment of the present invention. As shown in FIG. 3, method 300 may be used to determine various information regarding an environment in which photodetectors are present. Specifically, in the embodiment of FIG. 3, method 300 may be used to determine an illuminance value and an ambient light type using information from a device having multiple photodiodes. Based on this information, additional operations such as proximity sense operations may be performed. While the embodiment of FIG. 3 is with regard to a dual photodiode implementation, other exemplary embodiments are not so limited, and in other implementations a single photodiode or more than two photodiodes may be present. In the embodiment of FIG. 3, method 300 may be implemented using a controller of an IC that includes the photodetectors, as shown, for example, in FIGS. 1-2. However, in other embodiments, a general purpose processor or other microcontroller which may be of a different IC or other such device that is in communication with the photodetectors, may also be used.

As seen in FIG. 3, method 300 may begin by receiving information from multiple photodiodes (block 310). In one embodiment, this information may be signal strength ratio, frequency components, and absolute amplitude information from a pair of photodetectors, one of which is configured within a visible light spectrum and the other of which is configured within an infrared light spectrum. From these measurements, a color ratio may be calculated (block 320). In the most detailed embodiment, the ratio may be in accordance with the following equation:

R=Visible Photodiode Output/Infrared Photodiode Output.

In some embodiments, the IR detector may be configured at multiple wavelengths (e.g., a low and high IR spectrum) and a selected one of the resulting ratios may be used as described below.

Still referring to FIG. 3, based at least in part on this ratio, a correction value may be obtained (block 330). For example, a lookup table accessible to the controller may be accessed using the color ratio, and other information such as absolute IR value, frequency components, and peak-to-peak amplitudes to obtain the correction value. This correction value may be, in one embodiment, a value that compensates for the performance specification of the photo detectors. Then using at least one of the measurement values and the correction value, an illuminance value may be determined (block 340). For example, in one implementation, the illuminance value may be determined by in accordance with the following equation:

Illuminance=(V−A_{V/R}*IR)

where V=Visual photodiode output, IR=IR photodiode output, and A_{V/R} is the correction factor from the look up table, where the inputs to access the table include the color ratio of V/IR, absolute IR level, frequency components and their peak-to-peak amplitudes.

In other embodiments, a dual approximation based on color ratio may occur. Specifically for a color ratio of visible light (VIS)/infrared (IR) an illuminance value may be determined as follows:

lux=(VIS−IR*k1)*k2 where VIS/IR>=th

lux=(VIS−IR*k3)*k4 where VIS/IR<th

where th is a threshold level, and k1-k4 are coefficient pairs. More specifically, the coefficients k1-k2 and k3-k4 pairs are two different linear approximations for improved ALS correction depending on color ratio; k2-k1 for one approximation and k3-k4 for the other. Having two different approximations may optimize the approximation based on light source type. In this embodiment, the type of light source can be identified based on color ratio (and/or waveform in general). Note that it is possible to generate more than two approximations and select the most appropriate (e.g., most accurate) based on color ratio and waveform properties.

In addition to this determination of an illuminance value, embodiments may further determine an ambient light type. More specifically, at block 350 an ambient light type may be determined based on the color ratio, the signal strength information which may be the compensated or uncompensated photodiode output of either of the photodiodes, and in some embodiments further based on the above-described characteristics. Note that not all of the above inputs are required for the correction table. Generally, color ratio and absolute level (which determines sunlight levels) if used as inputs to the table will result in less than 10% luminance error over standard white light sources.

While the above discussion is with regard to an implementation in which information from multiple photodetectors is used, in some embodiments it may be possible to use information from just a single photodetector to determine an ambient light condition as well as an approximate luminance value. One application for such an embodiment may be with regard to automatic light switches that enable or disable lighting operations based on whether some light is present. In these embodiments, information regarding the measurement taken from a single photodetector can be used, along with characteristics of the information such as frequency and amplitude. Based on all of this information an approximate lux value can be determined based on the photodiode output itself and a correction factor. This correction factor may be obtained from a table which is accessed based on the absolute level of the photodiode output and/or its frequency components. For example, if the absolute value is greater than a given threshold, a first correction factor may be used, while for measurements below this threshold, frequency information obtained from the measurement information may be used to access a correction factor. Thus an approximate lux value may be determined based on the photodiode output and this correction factor. Still further, using the approximate lux value, an ambient light determination may be made. From all of this information, e.g., for a smart light switch an approximate illumination value itself may be used to determine the presence of daylight such that the switch can be turned off.

Referring back to FIG. 2, control signals can be provided from a controller 210 to a proximity sensor 100 in accordance with an embodiment of the present invention. These control signals can be used to select an operation mode, e.g., from a shutdown mode, multiple proximity-detection modes, multiple ambient-light sensing modes, and an offset calibration for high-sensitivity mode. Mode selection is accomplished through the sequencing of pins that receive the following signals in one embodiment: a SC (shutdown/clock), MD (mode), and STX (strobe/transmit) signals. The detector enters shutdown mode unconditionally when SC is high.

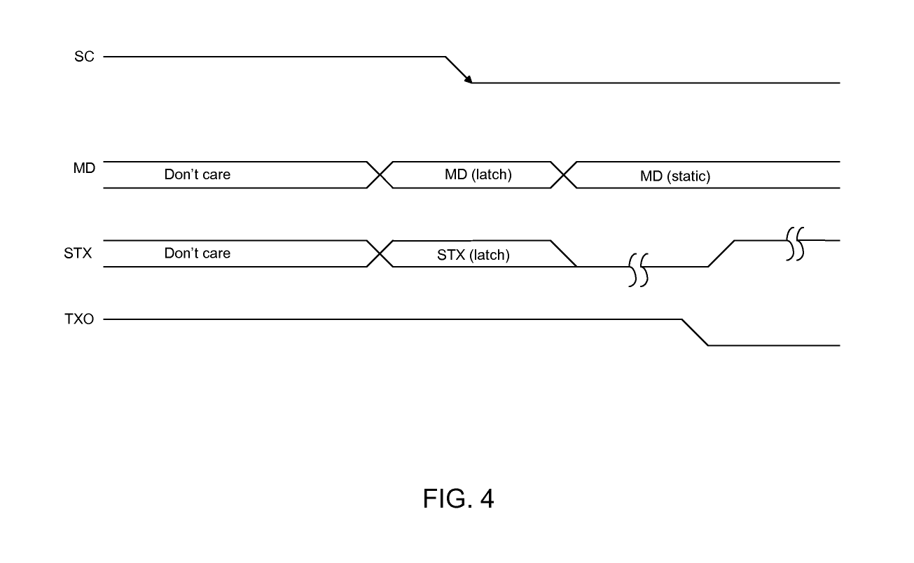

The active modes can be set by clocking the state of MD and STX on the falling edge of SC and then setting MD to the given state. Since setting SC high forces shutdown, SC is held low for the selected mode to remain active. The timing diagram of FIG. 4 illustrates an example programming sequence. Table 1 below indicates the various mode encodings for an exemplary embodiment. After the correct state has been programmed, the STX input can be used to trigger measurements.

TABLE 1

| | | STX | MD | MD |
|---|---|---|---|---|
| Mode | Description | (Latch) | (Latch) | (Static) |
| PRX400 | Proximity, 400 mA LED current | 0 | 0 | 0 |
| | (Mode 0) | | | |
| OFC | Offset calibration for high sensitivity | 0 | 0 | 1 |
| | (Mode 1) | | | |
| PRX50 | Proximity, 50 mA LED current | 0 | 1 | 0 |
| | (Mode 2) | | | |
| PRX50H | Proximity, 50 mA LED current, | 0 | 1 | 1 |
| | high reflectance (Mode 3) | | | |
| VIRL | Visible and infrared ambient, | 1 | 0 | 0 |
| | low range (Mode 4) | | | |
| VAMB | Visible ambient (Mode 5) | 1 | 0 | 1 |
| VIRH | Visible and infrared ambient, | 1 | 1 | 0 |
| | high range (Mode 6) | | | |
| (Reserved) | Reserved mode | 1 | 1 | 1 |

In proximity mode, an LED (e.g., LED 103 of FIG. 1) sends light pulses that are reflected from the target to a photodiode (e.g., photodiode 120) and processed by the analog circuitry of the detector 100. Light reflected from a proximate object is detected by the photodiode and is converted into a pulse of a duration proportional to the amount of reflected light. In one implementation, the LED can be turned off at the trailing edge of the PRX pulse, and the detection cycle may be aborted before the end of the PRX pulse by bringing STX low. This allows a system designer to limit the maximum LED “on” time in applications where high reflectivity periods are not of interest, thus saving power and minimizing the LED duty cycle. Aborting the detection cycle at a set time also enables fast threshold comparison by sampling the state of the PRX output at the trailing (e.g.,) edge of the STX input. An active (e.g., low) PRX output when STX falls means that an object is within the detection range. Forcing a shorter detection cycle also allows a faster proximity measurement rate, thus allowing more samples to be averaged for an overall increase in the signal-to-noise ratio. Different modes may be selected for different range detections.

An offset calibration mode works the same way as the other proximity modes but without turning on the LED. This allows precise measurement of the environment and internal offsets without any LED light being reflected. The offset calibration mode also allows compensation of drifts due to supply and temperature changes.

Choosing between which color ratio to use depends on the light intensity. In general, a ratio that uses a low IR measurement (VAMB/VIRL) may be used if the signal strength of the IR detector is below a threshold level, since this measurement may have higher sensitivity. For higher light intensities (e.g., above the threshold level), a ratio that uses a high IR measurement (VAMB/VIRH) ratio may be used.

Note that VAMB, VIRH, and VIRL pulse widths are used as dividends and divisors in these ratios. The pulse width offsets (at 0 lux) may be removed prior to usage in the above color ratios. These offsets may be obtained by taking VAMB, VIRH, and VIRL measurements at 0 lux and using actual measured values. Or predetermined values (e.g., 7.1 μs, 11.3 μs, and 9.9 μs) may be removed respectively from VAMB, VIRH, and VIRL (then assigning 0 μs to any resulting negative value).

Because VAMB arises from a small photodiode, and also has low response and may have significant amplification, it has significant noise and variable offset. Below a certain light level, it is more accurate to use VIRL but correct it for its infrared level by multiplying its output by a coefficient dependent on the infrared component of the light source. The light source can be identified or the correct coefficient in the lookup table can be determined by the ratio of DC to AC and/or the frequency components in the signal.

Once a color ratio has been determined, the light type(s) and lux ratios are also identified. The lux ratio describes the ratio between the desired lux value and VAMB, VIRL, or VIRH (depending on the situation). The appropriate lux ratio, when multiplied with the applicable measurement, yields the final calculated lux value. Without any calibration, it should be possible to arrive within 50% (or 50 lux) of the absolute lux value.

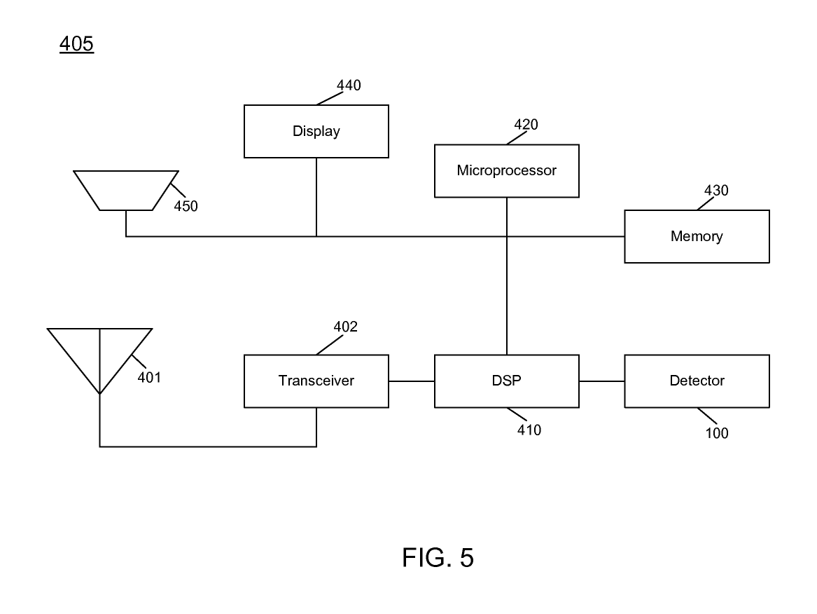

Referring now to FIG. 5, shown is a block diagram of a system 405, which may be a cellular telephone handset, personal digital assistant (PDA), or other such device in which a detector in accordance with an embodiment of the present invention is located. As shown, an antenna 401 may be coupled to a transceiver 402, which may transmit and receive radio frequency (RF) signals. In turn, transceiver 402 may be coupled to a digital signal processor (DSP) 410, which may handle processing of baseband communication signals. In turn, DSP 410 may be coupled to a microprocessor 420, such as a central processing unit (CPU) that may be used to control operation of system 405 and further handle processing of application programs, such as personal information management (PIM) programs, email client software, downloaded applications, and the like. Microprocessor 420 and DSP 410 may also be coupled to a memory 430. Memory 430 may include different memory components, such as a flash memory and a read only memory (ROM), although the scope of the present invention is not so limited.

Furthermore, as shown in FIG. 5, a display 440 may be present to provide display of information associated with telephone calls and application programs. Control of brightness of the display may be based on an ambient light detection and/or a proximity calculation performed based on information from a proximity detector 100, which may be a detector such as that of FIG. 1. Although the description makes reference to specific components of system 405, it is contemplated that numerous modifications and variations of the described and illustrated embodiments may be possible. For example, rather than using transceiver 402, depending on the desired application, in some embodiments one may use a receiver or a transmitter. Furthermore, transceiver 402 and/or DSP 410 may include an article in the form of a non-transitory machine-readable storage medium (or may be coupled to such an article, e.g., memory 430) onto which there are stored instructions and data that form software programs. The software programs may provide for control of transceiver 402, e.g., for controlling transmission of RF signals according to multiple communication protocols along one or more transmission paths, e.g., via control of which transmission path is selected and control of the selected transmission path (e.g., frequency, gain, timing and so forth) and non-selected path (e.g., via input of predetermined values). In addition, programs of DSP 410 may be used to control detector 100, and to enable determination of an ambient light type, illumination value, and detection of an object in proximity to system 405, such as a user. Based on the detection and illumination conditions, DSP 410 may control display 440 (e.g., to be brighter or darker) and a speaker 450 (e.g., to be louder or softer) accordingly.

Thus one example of a proximity detection application is controlling the display and speaker of a portable device such as a cellular telephone. In this type of application, the cellular telephone turns off the power-consuming display and disables the loudspeaker when the device is next to the user's ear, then reenables the display (and, optionally, the loudspeaker) when the phone moves more than, e.g., a few inches away from the ear. However, the scope of the present invention is not so limited, and other examples of display control include enabling and disabling a touch display to prevent “ear” dialing.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving measurement information from first and second photodetectors, the first photodetector configured for a visible light spectrum and the second photodetector configured for an infrared light spectrum;
calculating a color ratio using the measurement information from the first and second photodetectors;
obtaining a correction value using the color ratio and an absolute value of an output of at least one of the first and second photodetectors;
applying the correction value to at least one of the first and second measurement information to obtain a photopic illuminance value; and
determining, in a controller, an ambient light type using the photopic illumination value and the color ratio.

2. The method of claim 1, wherein the correction value is further obtained based on frequency components and amplitudes of the first and second photodetector outputs.

3. The method of claim 1, wherein the absolute value is an absolute infrared value.

4. The method of claim 3, wherein the correction value is based on characterization data stored in a lookup table accessible by the controller.

5. The method of claim 1, further comprising controlling a display of a portable device including the first and second photodetectors based on the ambient light type.

6. The method of claim 5, further comprising controlling the display further based on the photopic illuminance value.

7. The method of claim 1, further comprising receiving the measurement information from the second photodetector at a first range of the infrared light spectrum and a second range of the infrared light spectrum, the first and second ranges non-overlapping.

8. The method of claim 7, further comprising using the measurement information at the first range to determine the ambient light type if the photopic illuminance value is greater than a threshold level, and otherwise using the measurement information at the second range to determine the ambient light type.

9. The method of claim 1, further comprising receiving at least one electrical frequency and amplitude property from the first and the second photodetectors as part of the measurement information and determining the ambient light type further using the at least one electrical frequency and amplitude property.

10. An apparatus comprising:
a first photodetector to detect energy in one of a visible light spectrum and an infrared light spectrum; and
a controller coupled to the first photodetector to receive a first measurement from the first photodetector and to determine a correction value based on the first measurement, the first measurement including a frequency value and an amplitude value, the correction value obtained from a table using the frequency value and the amplitude value, and to determine an approximate luminance value using the first measurement and the correction value.

11. The apparatus of claim 10, further comprising a second photodetector to detect energy in the other of the visible light and infrared light spectra, wherein the controller is to receive a second measurement from the second photodetector and to calculate a color ratio between the first and second measurements, and to determine an ambient light type present in a vicinity of the apparatus based at least in part on the color ratio and one of the first and second measurements.

12. The apparatus of claim 11, further comprising:
a multiplexer coupled to receive the first and second measurements and to select for output one of the first and second measurements;
an amplifier to amplify the selected first or second measurement;
a comparator to compare the selected first or second measurement to a threshold value; and
a buffer coupled to the comparator to output a pulse width modulated signal representative of the comparator output, wherein the comparator output is the first or second measurement, based upon control of the multiplexer.

13. The apparatus of claim 11, wherein the apparatus comprises a package including an infrared emitter to provide an infrared signal to be detected by the second photodetector, the package further including a semiconductor die having the first and second photodetectors.

14. A portable device comprising:
a processor to perform application program instructions;
a transceiver to transmit and receive radio frequency (RF) signals;
a display to display information to a user;
a proximity detector having a first photodetector to detect energy in a visible light spectrum, a second photodetector to detect energy in an infrared light spectrum, a multiplexer coupled to the first and second photodetectors to receive first and second measurements therefrom and to select for output the first measurement at a first time and the second measurement at a second time responsive to a mode controller, an amplifier to amplify the first and second measurements, a comparator to compare each of the first and second measurements to a corresponding threshold value, and a buffer coupled to the comparator to output a pulse width modulated signal for each of the corresponding comparator outputs; and
a controller coupled to the proximity detector to receive the pulse width modulated signals and to calculate a color ratio between the detected energy in the infrared light spectrum and the visible light spectrum, and to determine an illuminance value present in a proximity of the portable device based at least in part on the color ratio, the pulse width modulated signals and a correction factor, wherein the controller is to determine the correction factor using the color ratio, an absolute value of the second measurement, and a frequency component and amplitude thereof.

15. The portable device of claim 14, wherein the controller is to determine an ambient light type present in the proximity using the illuminance value.

16. The portable device of claim 15, wherein the controller is to adjust a brightness of the display based on the ambient light type.

17. The portable device of claim 14, wherein the controller is to adjust the brightness of the display further based on a proximity detection with regard to the user.

18. The portable device of claim 14, wherein the first and second photodetectors employ different p-n junctions.

19. The portable device of claim 14, wherein the controller is coupled to an integrated circuit (IC) including the first and second photodetectors.

20. The portable device of claim 14, wherein the controller is to access a table to determine the correction factor.
